(19) United States
(12) Patent Application Publication
(10) Pub. No.: US 2007/0089229 A1
(43) Pub. Date: Apr. 26, 2007

(54) Sauna room

(76) Inventors: Yoshiaki Yatomi, Kitakyushu-shi (JP); Hajime Yamada, Kitakyushu-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/557,359

(22) PCT Filed: May 20, 2004
(86) PCT No.: PCT/JP04/07213

§ 371 Date: Nov. 9, 2006

(30) Foreign Application Priority Data
May 20, 2003 (JP) 2003-142666

(51) Int. Cl. A61H 33/06

(52) U.S. Cl. 4/524

(57) ABSTRACT

The present invention provides a sauna room which allows to bathe at a low temperature by utilizing the far-infrared ray effect of a radiator and is superior in hygiene, in safety by avoiding the possibility of falling over and burning, in energy savings without losing the far-infrared ray effect and in workability for construction and cleaning. The sauna room comprising a heat source having at least one selected from a group of a heating conduit, heating pipe and electric heating sheet which supply heat to a floor part, a mortar layer for bathers formed on the floor part with a predetermined height and width, a slab rock radiator radiating electromagnetic waves such as far-infrared rays which is embedded on the mortar layer for bathers exposing the surfaces thereof and a wastewater catchment part formed at least at one side of the mortar layer for bathers.

### TECHNICAL FIELD

The present invention relates to low-temperature sauna rooms utilizing the effects of far-infrared rays.

### Background Art

Sauna rooms currently employed for the purpose of stimulating perspiration of bathers to improve their health are usually co-equipped with facilities such as spas, and used by many people for reducing their weight or to feel exhilarated after taking a bath.

A conventional sauna room is explained by referring to a drawing as follows.

FIG. 14 is a side cross sectional view showing the outline of a conventional sauna room. In FIG. 14, Reference numeral 101 denotes a floor panel composed of wood and the like, Reference numeral 102 denotes a wall panel composed of wood or the like and vertically installed on the floor panel 101, Reference numeral 103 denotes a ceiling panel composed of wood or the like and disposed above the wall panel 102, Reference numeral 104 denotes a stove installed on the floor panel 101, Reference numeral 105 denotes a protective barrier composed of wood or the like and encircling the stove 104 and Reference numeral 106 denotes a chair composed of wood or the like and formed on the floor panel 101.

How the conventional sauna room constituted as mentioned above is used is explained as follows. As shown in FIG. 14, the room is heated by heated air or steam generated by the stove 104 to be maintained at a high temperature of around 100° C. or a high-temperature and high-humidity condition, and bathers sit on the chair 106 to stimulate their perspiration.

The conventional sauna room, however, has the following disadvantages.
(1) Use of large quantities of wood for the interior causes adhesion of organic substances on the wood surface, resulting in proliferation of saprophyte; this causes characteristic odors in the bath room, resulting in deterioration in terms of hygiene.
(2) Due to the temperature in the bath room being set at a high temperature of around 100° C., bathing for physically weak bathers such as the aged, children and women make it inaccessible to bathe.

To solve such disadvantages, various studies have been performed and are disclosed as follows.

(Patent Literature 1) discloses “laying in a room artificial ceramics having an effect to radiate far-infrared rays produced in the shape of sand, a sphere, particles, natural stone, powder, slab and the like, or a mixture of natural ceramics mixed there with, followed by heating such ceramics with a heater, hot water, heated air or the like to utilize the effect of the ceramics radiating far-infrared rays.”

(Patent Literature 2) discloses “disposing a heat insulating material layer at the lowest part, disposing a concrete layer thereon and further disposing a mortar layer thereon, embedding a hot water pipe therein and laying gravel and charcoal at the uppermost part, followed by circulating hot water supplied from a boiler with a circulating pump in the hot water pipe.”

(Patent Literature 1) Japanese Published Unexamined Patent Application No. H09-313565

(Patent Literature 2) Japanese Published Examined Utility Model Registration No. 3070524

The conventional arts mentioned above, however, have the following problems.
(1) The technology disclosed in the Patent Literature 1 has problems that it is less hygienic due to lack of a drainage system and it is trouble some and bother some for bathers to brush off sand adhered to their skin when going out of a sauna room because they bathe in sand.
(2) The technology disclosed in the Patent Literature 2 has problems that it is uncomfortable for bathers because their skin is pricked by the edges of gravel and charcoal when lying back down for bathing and bothersome to brush off gravel and charcoal when going out of a sauna room, it is especially difficult for washing off charcoal by pouring hot water, and it is inferior in maintenance ability to periodically replace gravel and charcoal for repeated use.

This invention intends to solve the conventional problems mentioned above, and to provide a sauna room for full immersion bathing or a foot bath which allows to bathe at a low temperature by utilizing a far-infrared ray effect of a radiator, and is superior in hygiene, in safety by avoiding the possibility of falling over and burning, in energy savings by utilizing the far-infrared ray effect and in workability for construction and cleaning.

### DISCLOSURE OF THE INVENTION

The sauna room of the invention includes the following constitutions to solve the conventional problems mentioned above.

The sauna room as set forth in Claim 1 includes a heat source having at least one selected from a group of a heating conduit, heating pipe and electric heating sheet which supply heat to a floor part, a mortar layer for bathers which is formed on the floor part with a predetermined height and width, a slab rock radiator radiating electromagnetic waves such as far-infrared rays which is embedded on the mortar layer for bathers exposing a surface thereof and a wastewater catchment part formed at least at one side of the mortar layer for bathers.

By virtue of such constitutions, following effects can be obtained.
(1) The heat supplied from the heat source such as a heated heating conduit, heating pipe, and electric heating sheet is conducted to the slab rock radiator, followed by radiation of far-infrared rays from the slab rock radiator in addition to the heat from the heat source to warm a bather by both of such heat and far-infrared rays; this enhances the sauna effect, allows to set a temperature of the heat source at a low level and enhances energy savings.
(2) Far-infrared ray effect of the slab rock radiator allows to set the temperature of the heat source at a low level, this allows a bather to bathe at a low temperature as well as the aged and patients suffering from high blood pressure or the like to bathe.
(3) Even if heating is stopped, the slab rock radiator has high thermal conductivity and radiates heat and far-infrared rays for a long time to the surrounding air, this enhances the heat insulation ability of the room.
(4) Formation of the wastewater catchment part at a side of the mortar layer for bathers allows wastewater of the mortar layer for bathers such as water droplets and sweat to readily drain out, resulting in enhancement of hygiene.
(5) Formation of the wastewater catchment part at a side of the mortar layer for bathers allows water for cleaning to readily drain out during cleaning work, resulting in enhancement of cleaning workability.
(6) When a powder radiator is uniformly dispersed in the mortar layer for bathers, the far-infrared ray effect allows to enhance the sauna effect.

As a heating part for the heating conduit, applied are electric water heaters and hot-water boilers fueled by gas, petroleum, kerosene and the like. As a medium for the heating conduit, water, antifreezing fluid, steam or the like may be applied. Especially in cold regions, antifreezing fluid is preferably applied as the medium.

As the heating conduit and heating pipe, applied are crosslinked polyethylene pipes, polybutene pipes, metal pipes and the like. Since crosslinked polyethylene pipes and polybutene pipes are advantageous in durability, strength, lightness in weight and superior processing ability, they are preferably applied.

The mortar layer for bathers is formed to fix the slab rock radiator.

As components for the mortar layer for bathers, applied are cement, river sand, powder silica and/or a powder radiator radiating electromagnetic waves such as far-infrared rays. The powder radiator radiating electromagnetic waves such as far-infrared rays is especially preferable due to its ability to enhance the far-infrared ray effect for bathers.

The material of the radiator includes natural ores such as conglomerate hornfels (Tensyo-Seki), radon ore, feldspar, tourmaline, radium ore, Bakuhan-Seki and granite, quartz, silica, artificial ceramics and the like. The conglomerate hornfels (Tensyo-Seki) are characterized by radiating far-infrared rays in a larger quantity than other substances radiating far-infrared rays, and particularly the far-infrared rays having a wavelength of 6 μm to 13 μm in high ratio; such a wavelength is easily absorbed by water, and the far-infrared rays having a water-absorbable wavelength activates white blood cells and lymphocytes in the body to suppress the formation of lipid peroxide, resulting in powerful effects to suppress skin diseases such as atopic dermatitis and proliferation of cancer cells; because of these characteristics, the conglomerate hornfels (Tensyo-Seki) are preferably applied. Since a large quantity of far-infrared rays are radiated by applying the conglomerate hornfels (Tensyo-Seki), moisture in a room where humidity is set to 60% to 95% can provide a sufficient sauna effect at a low temperature by virtue of the action of far-infrared rays. Since the water formed in a thickness of 1 μm to 10 μm selectively absorbs far-infrared rays, far-infrared rays are absorbed by steam (mono-molecular), resulting in enhancement of the sauna effect.

Powder silica is preferable because its heat conductivity is large and favorable to heat radiation from the mortar layer.

An average particle size of powder silica preferably applied is 0.05 mm to 6 mm, or preferably 0.2 mm to 4 mm. If the average particle size of silica becomes less than 0.2 mm, processing tends to require more labor; or if being larger than 4 mm, the strength of the mortar layer tends to be decreased. Particularly, if the average particle size of silica becomes less than 0.05 mm, processing ability is significantly decreased and handling ability becomes increasingly difficult due to too small a particle diameter; or if being larger than 6 mm, mixing becomes difficult and the strength of the mortar layer tends to be significantly decreased; therefore neither of such size ranges are preferable.

The mortar layer for bathers is formed for full immersion bathing in a size of 300 mm to 1200 mm in width and from 1500 mm to 2200 mm in length. If the width of the mortar layer for bathers is narrower than 300 mm, the bather tends to find it difficult to lie down; or if being wider than 1200 mm, the width tends to be broader than the bather's shoulder width, resulting in an occupancy area too large per bather; therefore neither of such size ranges are preferable.

If the length of the mortar layer for bathers is shorter than 1500 mm, a bather tends to find it difficult for lying down; or if being longer than 2200 mm, the length tends to be longer than the bather's body height, resulting in an occupancy area too large per bather; therefore neither of such size ranges are preferable.

The thickness (height) of the mortar layer for bathers is preferably 10 mm to 100 mm. If the thickness is thinner than 10 mm, the strength thereof tends to decrease and it tends to become difficult to firmly fix the slab rock radiator; or if being thicker than 100 mm, heat conduction tends to require more time; therefore neither of such thickness ranges are preferable.

For a foot bath, the width and length of the mortar layer for bathers is formed at a size that is equal to or more than 1 of the slab rock radiator for a foot bath can be disposed.

As the slab rock radiator, applied is one of the slab rock radiator mentioned above cut in a plate and ground or another one of a slab-rock-like shape formed by mixing the crushed material obtained by crushing the radiator mentioned above with cement and silica sand.

Applied disposition of the slab rock radiator includes one embedding a lower part of a single rectangular plate of the slab rock radiator in a mortar layer for bathers, one embedding a plurality of small rectangular slab rock radiators in the mortar layer for bathers in a tiled manner, one embedding a plurality of circular or rectangular slab rock radiators in the mortar layer for bathers spaced from each other and one embedding a plurality of rectangular rock slabs spaced from each other wherein the rectangular slab rock is formed in rectangular shape by disposing a plurality of small rectangular slab rock radiators in the mortar layer for bathers in a tiled manner. The one embedding a plurality of circular or small rectangular slab rock radiators in the mortar layer for bathers spaced from each other is especially preferably applied because it can be selectively installed at a position where high effect of far-infrared rays is expected by adjusting the position to a bather's position of shoulder, waist and the like, and is superior in workability in installment work.

When installing a rectangular single plate of the slab rock radiator, the slab rock radiator is formed in a size of approximately 200 mm to 800 mm in width and approximately 150 mm to 2000 mm in length. When the size of the slab rock radiator becomes smaller than 200 mm×150 mm, it tends to deteriorate the quantity of far-infrared rays radiated; when being larger than 800 mm×2000 mm, its energy efficiency tends to decrease; therefore neither of such size ranges are preferable.

When installing a plurality of small rectangular slab rock radiators in a tiled manner or a plurality of rectangular rock slabs spaced from each other wherein the rectangular rock slab is formed in a rectangular shape by disposing a plurality of small rectangular slab rock radiators in a tiled manner, the size of the slab rock radiator therefor is preferably 50 mm to 200 mm. If the size of the slab rock radiator becomes shorter than 50 mm, workability at a construction site tends to be deteriorated; or if being longer than 200 mm, arrangement of the slab rock radiator in a tiled manner tends to be difficult; therefore neither of such size ranges are preferable.

When installing a plurality of circular or rectangular slab rock radiators spaced from each other, an outside dimension thereof is preferably 200 mm to 500 mm. If the outside dimension of the slab rock radiator becomes shorter than 200 mm, it tends to deteriorate the quantity of the far-infrared rays radiated; if being longer than 500 mm, the width of the radiator tends to be unnecessary over the bather's width; therefore neither of such dimension ranges are preferable.

A thickness of the slab rock radiator is preferably applied in a size of 10 mm to 50 mm. This enhances the strength and the efficiency of the far-infrared ray radiation of the slab rock radiator. If the thickness becomes thinner than 10 mm, the slab rock radiator tends to be insufficient in its strength and the efficiency of the far-infrared ray radiation decreases; or if being thicker than 50 mm, the weight thereof increases resulting in a tendency to deteriorate transportability and installment workability at a construction site and tends to be time consuming for heat conduction; therefore neither of such thickness ranges are preferable.

A frame part enclosing the mortar layer for bathers and the wastewater catchment part may be formed.

A material applied to the frame part preferably includes elastomers such as rubber, woods such as white cedar, stones and the like. The woods such as white cedar are especially preferably applied due to their bacteriocidal property, strength and favorable processing ability.

A height of the frame part is preferably 10 mm to 50 mm to match that of the mortar layer for bathers. Application of the frame part protects the mortar layer for bathers from chipping off and allows to effectively lay cobbled stones of radiators as mentioned hereinafter.

The wastewater catchment part is disposed at a foot side of a bather or at two directions at the bather's sides.

The invention as set forth in Claim 2 is the sauna room as set forth in claim 1, wherein the sauna room includes a floor mortar layer disposed between the floor part and the mortar layer for bathers which contains a powder radiator radiating electromagnetic waves such as far-infrared rays.

By virtue of such constitutions, in addition to the effects provided by Claim 1, following effects can be obtained.
(1) The floor mortar layer containing a powder radiator radiating electromagnetic waves such as far-infrared rays is disposed between the floor part and the mortar layer for bathers, this enhances the heat retaining property and energy savings.
(2) The heat supplied from the heated heat source is conducted to the floor mortar layer to warm a bather with both of heat and far-infrared rays radiated from the floor mortar layer, this enhances the sauna effect, allows to set the temperature of the heat source at a low level and enhances energy savings.
(3) The far-infrared ray effect of the floor mortar layer can adjust the temperature of the heat source at a low level, this allows a bather to bathe at a low temperature, resulting in enhancement of safety by preventing the bather from burning, and also allows the aged and patients suffering from high blood pressure or the like to bathe.
(4) The powder radiator is uniformly dispersed in the floor mortar layer, this efficiently enhances the sauna effect by the far-infrared ray effect.

The components applied to the floor mortar layer are the same as that of the mortar layer for bathers mentioned above.

An average particle size of the powder radiator preferably applied is 0.01 mm to 0.5 mm. If the average particle size becomes less than 0.001 mm, processing tends to require more labor; or if being larger than 0.5 mm, the strength of the floor mortar layer and mortar layer for bathers tend to be decreased; therefore neither of such size ranges are preferable.

A mortar may be coated on the floor mortar layer to fix the slab rock radiator. This allows to support and fix a bottom face of the slab rock radiator.

The invention as set forth in Claim 3 is the sauna room as set forth in Claim 2, wherein the floor part includes a floor concrete slab layer, a waterproofing layer disposed on the floor concrete slab layer, a heat insulating material layer disposed on the waterproofing layer, a reinforcing wire mesh disposed on the heat insulating material layer and the heat source fixed to the reinforcing wire mesh, and the floor mortar layer is formed on the heat source.

By virtue of such constitutions, in addition to the effects provided by Claim 2, following effects can be obtained.
(1) The waterproofing layer prevents moisture coming out from the floor concrete slab layer, this enhances the heat retaining property as well as energy savings.
(2) The heat insulating material layer disposed on the floor part enhances heat retaining property as well as energy savings.
(3) The heat source is fixed to match a width of the reinforcing wire mesh to allow the heat sources to be placed in constant spacing, this enhances workability to fix the heat sources and prevents generation of locally heated spots on the floor part, which allows for uniform heating.
(4) The heat supplied from the heated heat source is conducted to the floor mortar layer to warm a bather with both of heat and far-infrared rays radiated from the floor mortar layer and the mortar layer for bathers, this enhances the sauna effect, allows to set the temperature of the heat source at a low level and enhances energy savings.

The material composing the waterproofing layer includes sheet waterproofing, asphalt waterproofing, coating waterproofing and the like. Of these, the sheet waterproofing is especially preferably applied due to its favorable durability and waterproofing property as well as its low cost.

As the insulator for the heat insulating material layer, applied are materials having high insulating ability like inorganic fibers such as glass wool and rock wool, foamed plastics such as foamed polystyrene and foamed polyurethane and wood-based fibers. Of these, foamed plastics such as foamed polystyrene are especially preferably applied due to their favorable insulating ability and durability.

As the material for the reinforcing wire mesh, applied are those made of metals or plastics. Of these, a mesh structured from plastic materials is especially preferably applied due to its lightweight, toughness and anti-stain ability.

The invention as set forth in Claim 4 is the sauna room according to any one of claims 1 to 3, wherein the sauna room includes a floor mortar covering layer formed by covering edges of the waterproofing layer, the heat insulating material layer and the reinforcing wire mesh on the floor part, a drain ditch formed at the floor mortar covering layer and/or the floor mortar layer and a drainage part connecting the wastewater catchment part to the drain ditch.

By virtue of such constitutions, in addition to the effects provided by any one of claims 1 to 3, following effects can be obtained.
(1) Unnecessary water derived from moisture and sweat of a bather can be readily drained out from the wastewater catchment part via the drainage part to the drain ditch, this allows the sauna room to be always maintained hygienic.
(2) The water used for cleaning the mortar layer for bathers and the slab rock radiator can be readily drained out from the wastewater catchment part via the drainage part to the drain ditch, this allows to enhance cleaning-work ability.
(3) The floor mortar covering layer formed by covering edges of the waterproofing layer, the heat insulating material layer and the reinforcing wire mesh can prevent the water drained to the drain ditch formed at the floor mortar covering layer and/or the floor mortar layer from penetrating into layers between from the waterproofing layer to the reinforcing wire mesh on the floor part, this enhances reliability.

When the wastewater catchment part is disposed in three directions other than the side of a bather's head resting, an edge of the drainage part may be optionally positioned as follows: a way to position at one place at a center of the side of a bather's foot resting, a way to position at two places at both edges of the side of a bather's foot resting or a way to position at three places in total at a center and both edges of the side of a bather's foot resting. The way to position at three places in total at a center and both edges of the side of a bather's foot resting is particularly preferable due to enhancement of drainage property.

When cobbled stones of conglomerate hornfels (Tensyo-Seki) or the like are laid in the drain ditch, moisture can be supplied to the cobbled stone, this allows far-infrared rays radiated from the cobbled stone to be absorbed by steam, resulting in enhancement of the far-infrared ray effect.

The invention as set forth in claim 5 is the sauna room according to any one of claims 1 to 4, wherein the sauna room includes a sheet layer reflecting far-infrared rays on an upper and/or lower face of the heat insulating material layer.

By virtue of such constitutions, in addition to the effects provided by any one of claims 1 to 4, following effects can be obtained.
(1) The sheet layer reflecting far-infrared rays on the floor part can reflect the radiated far-infrared rays to the inside of the room, this enhances efficiency of a sauna.
(2) If a sheet layer reflecting far-infrared rays is disposed under the heat insulating material layer, this not only enhances the far-infrared ray effect resulting from the action of far-infrared rays reflection but exerts a water shielding effect.
(3) If a sheet layer reflecting far-infrared rays is disposed under the reinforcing wire mesh, this reflects even infrared rays and enhances energy savings.

As the sheet layer reflecting far-infrared rays, applied are aluminum sheets, aluminum sheets containing glass, ceramic-coated sheets and the like. Of these, especially preferably applied are aluminum sheets containing glass and ceramic-coated sheets due to their strength and favorable ability to reflect far-infrared rays.

The invention as set forth in claim 6 is the sauna room according to any one of claims 1 to 5, wherein the sauna room includes a detachable or fixed inclined mortar layer including a powder radiator radiating electromagnetic waves such as far-infrared rays which are formed at least at one side part of the mortar layer for bathers in a manner that any one of the edges in longitudinal direction thereof inclines downwards and a cobbled stone part formed by laying cobbled stones of radiators on the inclined mortar layer or by embedding cobbled stones of radiators on the inclined mortar layer exposing the surfaces thereof.

By virtue of such constitutions, in addition to the effects provided by any one of claims 1 to 5, following effects can be obtained.
(1) The cobbled stone part is formed by laying or embedding cobbled stones of radiators on the inclined mortar layer, this allows the water passed through the cobbled stone part to readily flow down to the drainage part, resulting in enhancement of drainage property to maintain hygiene.
(2) If the inclined mortar layer is detachable, it can be taken off for cleaning; this allows for washing every corner with a floor brush having soft bristles, steam cleaner or the like and to enhance cleaning-work ability and hygiene.
(3) Due to disposition of the inclined mortar layer containing radiators and the cobbled stone part of radiator, adjusting the humidity of a room to 60% to 95% allows to enhance the far-infrared ray effect with the far-infrared rays radiated from not only the slab rock radiator but the inclined mortar layer and the cobbled stone part.
(4) Formation of the cobbled stone part allows to readily flow down, without accumulating unnecessary water coming from above, this enhances hygiene. Furthermore, the cobbled stones laid are recoverable for washing, this also enhances hygiene.
(5) Embedding the cobbled stones on the inclined mortar layer exposing the surfaces thereof does not allow the cobbled stones to be scattered, this prevents stones from being stolen and enhances cleaning-work ability.
(6) Embedding the cobbled stones on the inclined mortar layer exposing the surfaces thereof allows to produce a wastewater catchment part in a plant to transport to a construction site, this allows to enhance productivity.

The components applied to the inclined mortar layer are the same as that of the mortar layer for bathers mentioned above.

An inclination of the inclined mortar layer is preferably applied in a range of 2/100 to 10/100. If the inclination is smaller than 2/100, the drainage property tends to be worse. The upper limit of the inclination is determined in the range up to 10/100 to adjust a height of the mortar layer for bathers.

As the cobbled stone, preferably applied is one shaping natural stone of a radiator such as conglomerate hornfels (Tensyo-Seki) in a sphere having a diameter of 10 to 40 mm. If the diameter of the cobbled stone becomes smaller than 10 mm, it tends to deteriorate drainage property; or if being larger than 40 mm, it tends to be difficult for laying uniformly on an upper surface of the inclined mortar layer due to too much unevenness; therefore neither of such diameter ranges is preferable. Applying the conglomerate hornfels (Tensyo-Seki) as a natural stone is especially preferable because it can enhance the far-infrared ray effect as well as a deodorizing effect by its ability to decompose sweat odors.

When laying the cobbled stones, the way for it to be applied is a way laying the cobbled stones as they are or a way laying the cobbled stones after being put in a meshed net and the like. The way to lay the cobbled stones after being put in a meshed net is especially preferably applied because it allows to take out the cobbled stone part together with the meshed net for cleaning so that cleaning work can be performed without scattering the cobbled stones and its workability is enhanced.

The way to embed the cobbled stones on the inclined mortar layer includes a way that the cobbled stones are embedded by approximately half way thereof in the inclined mortar layer to preserve unevenness or a way that the cobbled stones are embedded by approximately half way thereof in the inclined mortar layer, followed by grinding the unevenness of the cobbled stone to make it flat. The way to embed the cobbled stone by approximately half way thereof in the inclined mortar layer to preserve unevenness is especially preferably applied because friction caused by the unevenness prevents a bather from slipping in the inclined mortar layer.

The invention as set forth in claim 7 is the sauna room according to any one of claims 1 to 6, wherein the sauna room includes a side wall part vertically installed around the floor part and having the heat insulating material layer and/or the sheet layer reflecting far-infrared rays therein, a ceiling part installed above the side wall part and having the heat insulating material layer and/or the sheet layer reflecting far-infrared rays therein and a mortar layer for wall coating on a wall at room side of the side wall part.

By virtue of such constitutions, in addition to the effects provided by any one of claims 1 to 6, following effects can be obtained.
(1) The heat insulating material layer and the sheet layer reflecting far-infrared rays applied to the side wall part and the ceiling part reflects heat (infrared rays) and far-infrared rays radiated back to the room, this enhances heat efficiency and energy saving.
(2) The side wall part and the ceiling part have the heat insulating material layer and the sheet layer reflecting far-infrared rays, this enhances the heat retaining property of the room and allows to set the temperature of the heat source at a low level, resulting in allowing a bather to bathe at a low temperature as well as the aged and patients suffering from high blood pressure or the like to bathe.

As the materials applied to the side wall part and the ceiling part, preferable is one having a waterproofing property or being subjected to waterproofing treatment, having low heat conductivity and heat accumulation ability and being flame resistant.

The components applied to the mortar layer for wall are the same as that of the mortar layer for bathers mentioned above.

The side wall part may be laid with tiles. When a powder obtained by crushing a radiator such as conglomerate hornfels (Tensyo-Seki) or a charcoal paint is coated on the mortar layer for wall and the tile, the room is allowed to be fully filled with anions, resulting in enhancement of mitigation effect.

The invention as set forth in Claim 8 is the sauna room according to any one of claims 2 to 7, wherein the sauna room includes the floor mortar layer formed in a manner of inclining from a side of a side wall downward to the drain ditch and a water spray bar equipped to the side of the side wall.

By virtue of such constitutions, in addition to the effects provided by any one of claims 2 to 7, following effects can be obtained.
(1) The floor mortar layer is formed in a manner of slightly inclining downward to the drain ditch, this allows to naturally drain the cleaning water out to the drain ditch during cleaning work, resulting in enhancement of cleaning-work ability.
(2) By spraying water from the water spray bar equipped to the side of the side wall when the humidity in the room decreases, the humidity can be increased to shift to the high humidity side.
(3) A high humidity state is always maintained by spraying water with the water spray bar, this allows to obtain at a high efficiency the far-infrared ray effect of conglomerate hornfels (Tensyo-Seki) and the like, resulting in enhancement of energy savings.

The inclining angle of the floor mortar layer is adjusted to 2/100 to 10/100. This allows to drain out the cleaning water as well as to wet the whole floor area in a short time while being sprayed by the water spray bar.

The temperature of water sprayed by the water spray bar is adjusted at 40° C.±10° C., or preferably 4° C.±3° C. This allows to maintain a high humidity condition without changing the room temperature significantly and also to maintain the sauna room comfortably.

The invention as set forth in claim 9 is the sauna room according to any one of claims 1 to 8, wherein the sauna room includes a chair for a foot bath disposed at a side of the bathing part where a bather sits by resting the bather's feet on the slab rock radiator of the mortar layer for bathers.

By virtue of such constitutions, in addition to the effects provided by any one of claims 1 to 8, following effects can be obtained.
(1) Since the chair is disposed at a side of the bathing part where a bather sits, the bather can easily sit thereon by resting the bather's feet on the slab rock radiator of the mortar layer for bathers; this allows the bather to warm the bather's soles by foot bath, and especially to relieve in a short time foot swelling resulting from working in a standing position and the like.
(2) Even a bather that finds it impossible to lie down on the mortar layer for bathers or stand up therefrom by the bather himself/herself can easily perform a foot bath only by sitting on the chair for a foot bath and resting the bather's feet on the slab rock radiator of the mortar layer for bathers.
(3) Sitting on the chair for a foot bath to warm a bather from the bather's soles with the slab rock radiator, this allows to enhance blood circulation even in the soles located furthest apart from the heart, to smoothly stimulate perspiration and to enhance the sauna effect.

As the material applied to the chair for a foot bath, preferably applied is a wood such as white cedar. The chair for a foot bath may be one suitable for bathers to sit thereon, and may include one to sit on by a bather alone or one like a bench to sit on by several bathers side by side. The shape of the chair for a foot bath may be one having legs under a seat to sit on by a bather to support the seat or one simply having a box shape. When the chair for a foot bath is not fixed to the sauna room, it can be easily moved or take in/out from the sauna room, resulting in enhancement of hygiene and maintenance ability. If the chair for a foot bath is foldable, it is especially easy to take in/out from the sauna room.

When several bathers sit side by side on the chair for a foot bath, it is formed in a length of 1500 mm to 2200 mm to match the length of the mortar layer for bathers. This allows for 2 to 4 bathers for a foot bath at the same time.

The height of the chair for a foot bath is formed in a range of 300 mm to 800 mm. If the height of the chair for a foot bath becomes lower than 300 mm, it tends to be difficult to sit in a comfortable position and to stand up; or if being higher than 800 mm, it tends to be difficult to firmly contact the soles to the slab rock radiator and to sit back; neither of such height ranges are preferable.

The invention as set forth in claim 10 is the sauna room as set forth in Claim 9, wherein the chair for a foot bath includes the heat source supplying heat to a seat of the chair for a foot bath, a mortar layer for chairs formed on the heat source including the powder radiator radiating electromagnetic waves such as far-infrared rays and the slab rock radiator embedded on the mortar layer for chairs exposing the surfaces thereof.

By virtue of such constitutions, in addition to the effects provided by Claim 9, following effects can be obtained.
(1) The heat radiated from the heated heat source is conducted to the slab rock radiator via the mortar layer for chairs, followed by radiation of far-infrared rays from the radiator of the mortar layer for chairs and the slab rock radiator in addition to the heat from the heat source; and both of such heat and far-infrared rays enable to warm the whole lower half of bather's body such as the thighs and bottom, to enhance the sauna effect, to set the temperature of the heat source at a low level and to enhance energy savings.
(2) The far-infrared ray effect of the radiator enables to set the heat source at a low temperature level, this allows a bather to bathe at a low temperature as well as the aged and patients suffering from high blood pressure or the like to bathe.
(3) The slab rock radiator has high heat conductivity and radiates heat and far-infrared rays to the surrounding air for a long time, this allows to enhance the heat insulation effect of the room, to warm the whole body of a bather and to obtain the sauna effect.

When sitting on a chair for a foot bath, the mortar layer for wall is arranged to touch a bather's waist, back, shoulder or the like by resting the bather's back on such a mortar layer forwall, far-infrared rays radiated from the radiator contained in the mortar layer for wall directly acts on the upper half of the bather's body, resulting in enhancement of the sauna effect.

When the slab rock radiator and the cobbled stone of radiator are embedded on the mortar layer for wall exposing their surface, the far-infrared ray effect is further enhanced up to an order at which the sauna effect can be provided only by sitting on the chair for a foot bath as much as by lying on the mortar layer for bathers; this allows even a bather with a disabled leg to easily bathe.

The invention as set forth in Claim 11 is the sauna room according to any one of claims 1 to 10, wherein each of the floor mortar layer, the inclined mortar layer, the mortar layer for bathers, the mortar layer for wall and the mortar layer for chairs includes on the basis of a powder silica of 100 parts by weight a cement of 25 to 45 parts by weight, or preferably of 30 to 40 parts by weight, and the radiator of 3 to 30 parts by weight, or preferably of 5 to 15 parts by weight.

By virtue of such constitutions, in addition to the effects provided by any one of claims 1 to 10, following effects can be obtained.
(1) The silica has favorable heat-radiation ability, this allows heat to be efficiently radiated from an abundant mass consisting of each mortar layer.
(2) The radiator is a powder form and uniformly dispersed in the mortar layers, this allows far-infrared rays to be abundantly radiated by heat conduction from the heat source.

A composition ratio of the powder silica, the cement and the far-infrared ray radiator mentioned above is on the basis of a powder silica of 100 parts by weight a cement of 25 to 45 parts by weight, or preferably of 30 to 40 parts by weight, and the far-infrared ray radiator mentioned above of 3 to 30 parts by weight, or preferably of 5 to 15 parts by weight. If the content of cement becomes less than 30 parts by weight, fixing ability and time required for fixing tend to decrease; or if being more than 40 parts by weight, heat conductivity tends to decrease. If the content of the cement becomes less than 25 parts by weight, fixing ability significantly decreases and the strength of each mortar layer tends to decrease; or if being more than 45 parts by weight, heat conductivity significantly decreases as well as durability tends to decrease; therefor neither of such content ranges are preferable.

If the content of the far-infrared ray radiator becomes less than 5 parts by weight, the effect of far-infrared rays tends to decrease; or if being more than 15 parts by weight, the sauna effect per cost tends to be improved not so much. If the content of far-infrared ray radiator becomes less than 3 parts by weight, the quantity of far-infrared rays radiated significantly decreases, resulting in reduction of practicability; or if being more than 30 parts by weight, the quantity of far-infrared rays radiated is unnecessarily increased, resulting in deterioration of cost performance; therefore neither of such content ranges are preferable.

The invention as set forth in Claim 12 is the sauna room according to any one of claims 1 to 11, wherein an average particle diameter of the radiator is 0.001 mm to 0.5 mm.

By virtue of such constitutions, in addition to the effects provided by any one of claims 1 to 11, following effects can be obtained.
(1) Average particle diameter of the radiator is small, this allows uniform dispersion and large surface area, resulting in enhancement of the far-infrared ray effect. Additionally, allowing the forming work of each mortar layer to be easy, results in enhancement of workability.
(2) A mortar having a fine texture can be produced, this allows each mortar layer to have a smooth surface, resulting in enhancement of hygiene.
(3) If the particle diameter is small, an abundant quantity of far-infrared rays can be radiated by being sufficiently dispersed, resulting in enhancement of the sauna effect at a low temperature.

If the average particle diameter of the radiator becomes less than 0.001 mm, self-cohesive power thereof becomes strong, this tends to be difficult to uniformly disperse to the system; or if being more than 0.5 mm, the surface area decreases, this decreases the quantity of the far-infrared rays radiated, resulting in difficulty to obtain the sauna effect at a low temperature; therefore neither of such diameter ranges are preferable.

The invention as set forth in claim 13 is the sauna room according to any one of claims 1 to 12, wherein humidity of a room is maintained in a range of an intermediate to a high humidity of 60% to 95%.

By virtue of such constitutions, in addition to the effects provided by any one of claims 1 to 12, following effects can be obtained.
(1) The humidity inside the room is maintained in a range of an intermediate to a high humidity of 60% to 95%, this allows far-infrared rays to be absorbed by the water in the moisture in the room, resulting in a sufficient sauna effect even at a low temperature.
(2) The humidity inside the room is maintained in a range of an intermediate to a high humidity of 60% to 95%, this allows a bather having diseases of the nose, throat, respiratory system or the like to bathe safely and to mitigate the bather's symptoms with the humidity in the room.

As the means to generate steam, installing a humidifier or supplying hot water with a combination tap disposed may maintain the humidity.

If the room humidity becomes lower than 60%, the quantity of far-infrared rays absorbed by the water in moisture tends to decrease due to shortage of room humidity, this results in difficulty to obtain a sufficient sauna effect at a low temperature due to reduction of the far-infrared ray effect; or if being more than 95%, this tends to increase uncomfortableness as well as to deteriorate humidity control property and operation stability; neither of the humidity ranges are preferable.

### BRIEF DESCRIPTION OF DRAWINGS

FIG. 1 is a sectional side view showing the outline of a sauna room of Embodiment 1.

FIG. 2 is an expanded view showing the outline of A part in FIG. 1.

FIG. 3 is an expanded view showing the outline of B part in FIG. 1.

FIG. 4A is a sectional view taken on line C-C of FIG. 1 as seen from the arrow direction.

FIG. 4B is an expanded view showing the outline of D part in FIG. 4A.

FIG. 5 is a sectional view taken out along an arrow of E-E of FIG. 4B.

FIG. 6 is a sectional view taken out along an arrow of F-F of FIG. 4B.

FIG. 7 is a sectional side view showing the outline of a sauna room of Embodiment 2.

FIG. 8 is an expanded view showing the outline of a bathing part of a sauna room of Embodiment 2.

FIG. 9 is a sectional side view showing the outline of a sauna room of Embodiment 3.

FIG. 10 is an expanded view showing the outline of G part in FIG. 9.

FIG. 11 is a sectional view taken on line H-H of FIG. 9 as seen from the arrow direction.

FIG. 12 is a sectional view taken on line I-I of FIG. 11 as seen from the arrow direction.

FIG. 13 is a sectional view taken on line J-J of FIG. 11 as seen from the arrow direction

FIG. 14 is a sectional side view showing the outline of a conventional sauna room.

### BEST MODES FOR CARRYING OUT THE INVENTION

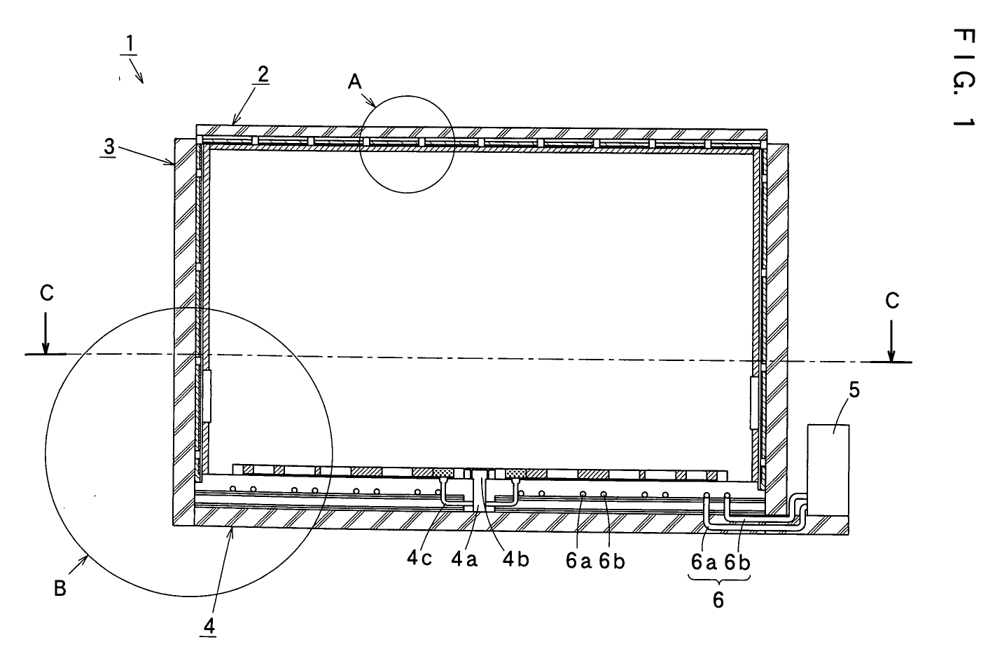

One of the embodiments of the invention is explained by referring to FIG. 1 to 6.

(Embodiment 1)

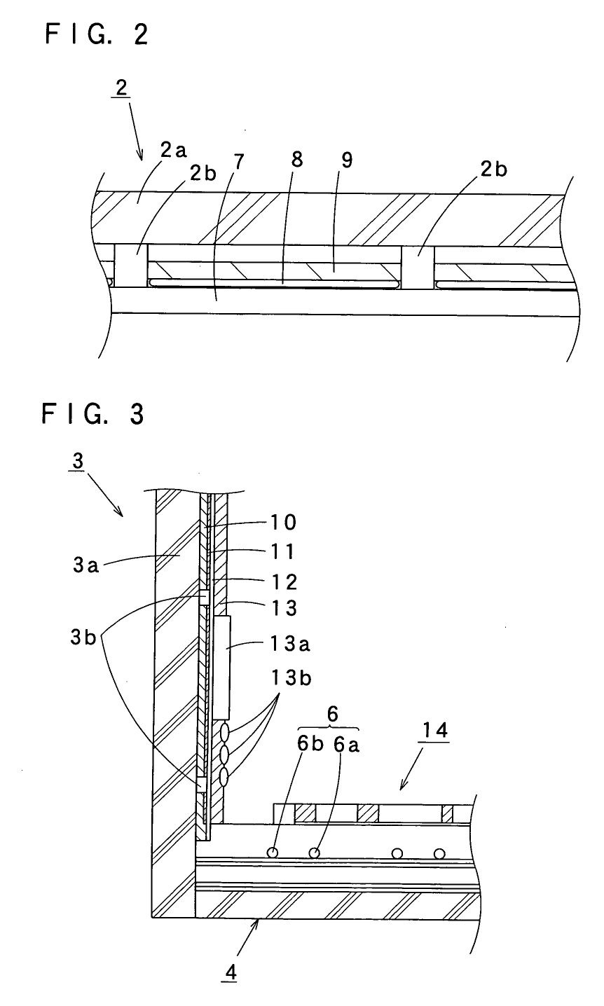

FIG. 1 is a sectional side view showing the outline of a sauna room of Embodiment 1, FIG. 2 is an expanded view showing the outline of A part in FIG. 1, FIG. 3 is an expanded view showing the outline of B part in FIG. 1.

In FIG. 1, Reference numeral 1 denotes a sauna room in Embodiment 1, Reference numeral 2 denotes a ceiling part of the sauna room 1, Reference numeral 3 denotes a side wall part of the sauna room 1, Reference numeral 4 denotes a floor part of the sauna room 1, Reference numeral 4a denotes a drain ditch formed at approximately the central part of the floor part 4 along the longitudinal direction thereof orthogonal to the longitudinal direction, Reference numeral 4b denotes a walking plank such as floor grates which is made from planks of wood, ceramic, metal or the like and disposed covering the drain ditch 4a, Reference numeral 4c denotes a drainage part opening to a bottom face of a wastewater catchment part 17 mentioned herein after and being connected to the drain ditch 4a, Reference numeral 5 denotes a heating part including hot-water boilers or the like and being disposed outside of the sauna room 1 and Reference numeral 6 denotes a heat source including a heating conduit having a hot-water supplying pipe 6a and a hot-water refluxing pipe 6b which are composed of crosslinked polyethylene pipes and the like, embedded in the floor part 4 and connecting to the heating part 5 via the side wall part 3.

In FIG. 2, Reference numeral 2a denotes a ceiling concrete, Reference numeral 2b denotes a ceiling horizontal member, Reference numeral 7 denotes a ceiling board composed of a flame resistant material having waterproofing property and heat-accumulating property and fixed under the lower face of the ceiling horizontal member 2b, Reference numeral 8 denotes a sheet layer reflecting far-infrared rays composed of aluminum sheets or the like and laid on the ceiling board 7 without any remaining space and Reference numeral 9 denotes a heat insulating material layer formed with a foamed resin plate such as foamed polystyrenes and disposed on the sheet layer reflecting far-infrared rays 8 without any remaining space.

In FIG. 3, Reference numeral 3a denotes a wall concrete, Reference numeral 3b denotes a wall furring strip, Reference numeral 10 denotes a heat insulating material layer formed with a resin foam plate and disposed in the gaps between the wall furring strips 3b installed on the wall concrete 3a at the room side thereof, Reference numeral 11 denotes a sheet layer reflecting far-infrared rays composed of aluminum sheets or the like and fixed on the heat insulating material layer 10 at the room side thereof, Reference numeral 12 denotes an inner wall material composed of a flame resistant material having waterproofing property and heat-accumulating property and fixed on the wall furring strip 3b at the room side thereof, Reference numeral 13 denotes a mortar layer for wall which contains a powder radiator radiating electromagnetic waves such as far-infrared rays composed of powder of conglomerate hornfels (Tensyo-Seki) or the like and is coated on the inner wall material 12 at the room side thereof, Reference numeral 13a denotes a slab rock radiator for walls embedded on the mortar layer for wall 13 exposing the surfaces thereof and formed with conglomerate hornfels (Tensyo-Seki) or the like which radiates electromagnetic waves such as far-infrared rays, Reference numeral 13b denotes a cobbled stone part of wall embedded on the mortar layer for wall 13 exposing the surfaces thereof and composed of a natural stone radiator or the like such as conglomerate hornfels (Tensyo-Seki) which radiates electromagnetic waves such as far-infrared rays and Reference numeral 14 denotes a bathing part on which a bather lies down for taking bedrock bathing.

In this embodiment, although the heat source 6 is explained with a case of the heating conduit having a hot water medium, the medium may be antifreezing fluids or steam, or a heating pipe or an electric heating sheet may be applied in place of the heating conduit.

A floor face is explained.

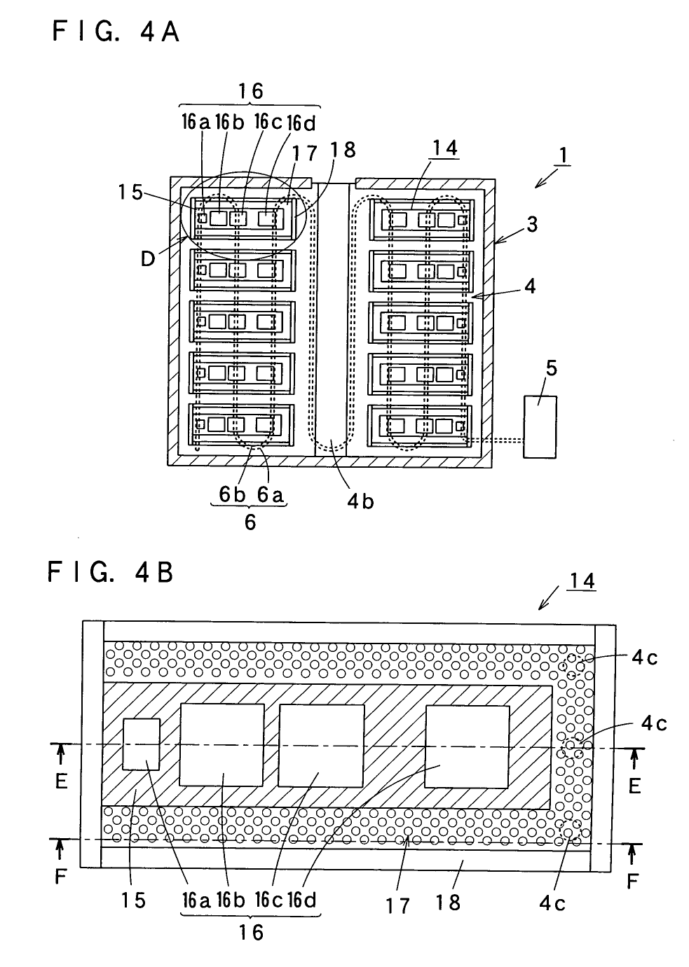

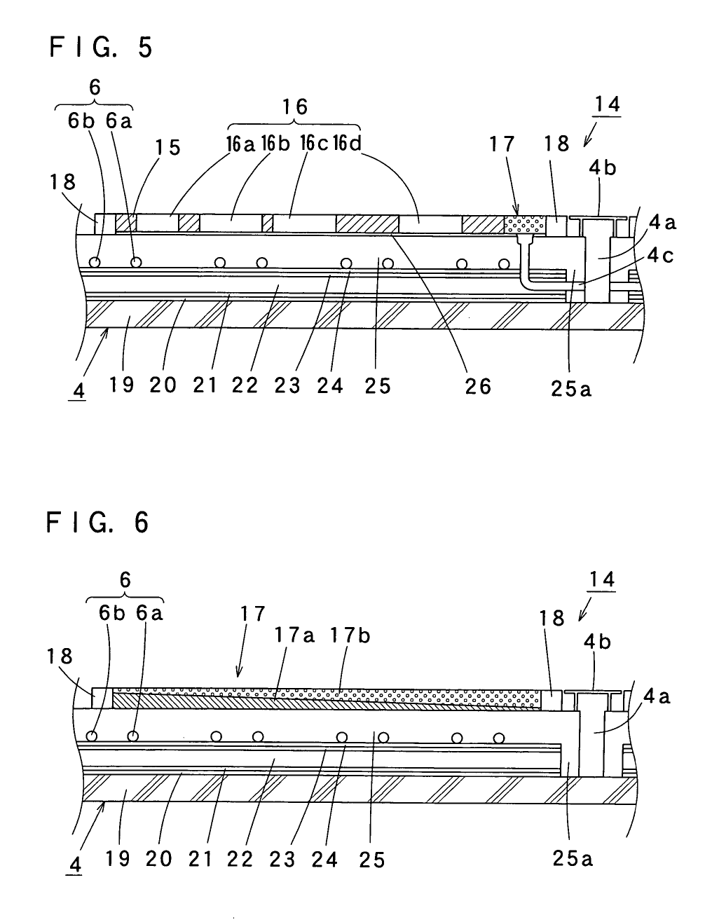

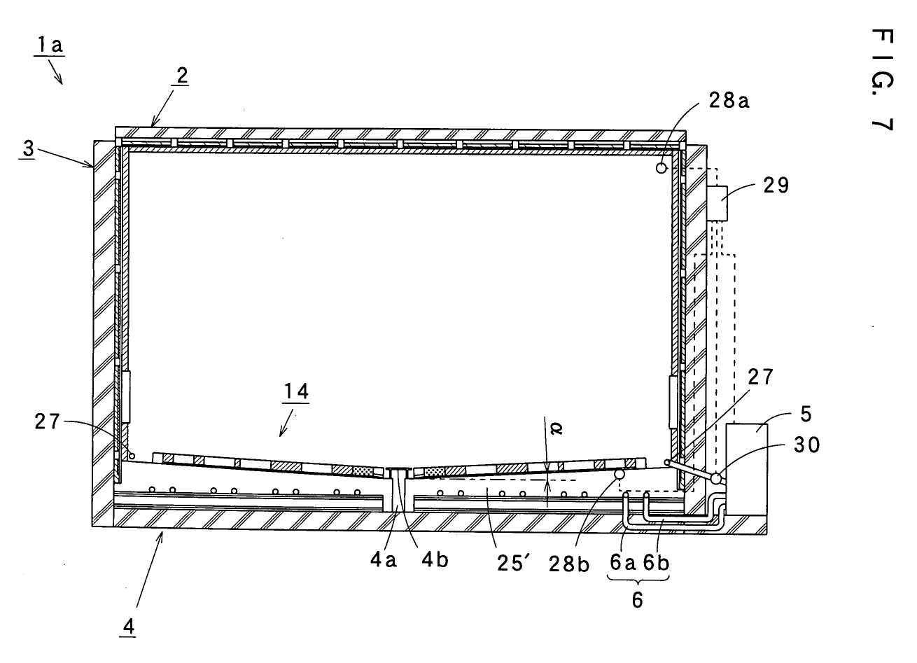

FIG. 4A is a sectional view taken on line C-C of FIG. 1 as seen from the arrow direction, FIG. 4B is an expanded view showing the outline of D part in FIG. 4A, FIG. 5 is a sectional view taken on line E-E of FIG. 4B as seen from the arrow direction and FIG. 6 is a sectional view taken on line F-F of FIG. 4B as seen from the arrow direction.

In FIG. 4A and FIG. 4B, Reference numeral 14 denotes the bathing part, Reference numeral 15 denotes a mortar layer for bathers which contains a powder radiator radiating electromagnetic waves such as far-infrared rays composed of powder of natural radiators such as conglomerate hornfels (Tensyo-Seki) or the like and is formed on the floor part 4 in the bathing part 14, Reference numeral 16 denotes a slab rock radiator formed from conglomerate hornfels (Tensyo-Seki) or the like radiating electromagnetic waves such as far-infrared rays, including a slab rock radiator for head 16a, a slab rock radiator for back 16b, a slab rock radiator for waist 16c and a slab rock radiator for foot 16d which are embedded exposing their surfaces at positions corresponding to a bather's head, back, waist and feet respectively when the bather is lying back down, Reference numeral 17 denotes the wastewater catchment part having a cobbled stone part 17b mentioned hereinafter in which a cobbled stone is laid all over the floor part 4 in three directions thereof (roughly an overturned U character shape) other than the side of a bather's head resting thereof on the mortar layer for bathers 15 and Reference numeral 18 denotes a frame part enclosing the mortar layer for bathers 15 and the wastewater catchment part 17 and laying out the bathing part 14 disposed on the floor part 4.

In FIG. 5, Reference numeral 19 denotes a floor concrete slab layer of the floor part 4, Reference numeral 20 denotes a waterproofing layer of the floor part 4 which is composed of waterproof sheets, rubber layers or the like and disposed on the floor concrete slab layer 19, Reference numeral 21 denotes a sheet layer reflecting far-infrared rays of the floor part 4 which is composed of aluminum sheets or the like and disposed on the waterproofing layer 20, Reference numeral 22 denotes a heat insulating material layer of the floor part 4 which is formed with resin foam plates and disposed on the sheet layer reflecting far-infrared rays 21, Reference numeral 23 denotes a sheet layer reflecting far-infrared rays of the floor part 4 which is composed of aluminum sheets or the like and disposed on the heat insulating material layer 22, Reference numeral 24 denotes a reinforcing wire mesh of the floor part 4 disposed on the sheet layer reflecting far-infrared rays 23 with fixing the heat source 6 thereon, Reference numeral 25 denotes a floor mortar layer which is formed on the heat source 6 and contains a powder radiator radiating electromagnetic waves such as far-infrared rays composed of powder of conglomerate hornfels (Tensyo-Seki) and the like, Reference numeral 25a denotes a floor mortar covering layer covering edges of the waterproofing layer 20, the sheet layer reflecting far-infrared rays 21, the heat insulating material layer 22, the sheet layer reflecting far-infrared rays 23 and therein forcing wire mesh 24 and forming the drain ditch 4a on the floor concrete slab layer 19 and Reference numeral 26 denotes a fixing mortar to fix the slab rock radiator 16 coated on the floor mortar layer 25 to the floor mortar layer 25.

In FIG. 6, Reference numeral 17a denotes an inclined mortar layer formed on the floor part 4 in three directions thereof other than the side of a bather's head resting thereof on the mortar layer for bathers 15 by inclining downward to the side of the bather's feet resting and Reference numeral 17b denotes a cobbled stone part formed by packing a cobbled stone of radiator on the inclined mortar layer 17a. The wastewater catchment part 17 includes the inclined mortar layer 17a and the cobbled stone part 17b. Although the inclined mortar layer 17a is formed by inclining to lower the foot side thereof, the inclined mortar layer 17a may be eliminated by inclining the floor mortar layer 25 to lower the foot side thereof.

In Embodiment 1, the slab rock radiator 16 is formed in a rectangular shape having a thickness of approximately 20 mm to 50 mm and a plurality thereof is arranged in a predetermined spacing. The mortar layer for bathers 15 is formed to have the same plane with the slab rock radiator 16. The frame part 18 is formed in a size of approximately 600 mm to 1300 mm in width and approximately 1700 mm to 2300 mm in length.

The drainage part 4c is connected from around a lower edge of the wastewater catchment part 17 to the drainage part 4a. The drainage parts 4c are formed at 1 to 3 positions equally spaced at the side of the bather's foot resting.

As the drain ditch 4a is formed on the floor concrete slab layer 19 with the floor mortar covering layer 25a covering edges of the waterproofing layer 20, the sheet layer reflecting far-infrared rays 21, the heat insulating material layer 22, the sheet layer reflecting far-infrared rays 23 and the reinforcing wire mesh 24, the drainage drained from the wastewater catchment part 17 to the drain ditch 4a via the drainage part 4c does not penetrate into the layers between the waterproofing layer 20 to the reinforcing wire mesh 24, this enhances reliability.

The wastewater catchment part 17 is formed with the inclined mortar layer 17a having an inclination of approximately 2/100 inclining downward to the side of the foot resting and the cobbled stone part 17b formed by laying the cobbled stones having a diameter of 5 to 40 mm on the inclined mortar layer 17a. The cobbled stone part 17b may be formed, other than by laying the cobbled stones themselves on the inclined mortar layer 17a, by laying the cobbled stones contained in a net or the like to be shaped in a transportable form or by embedding and washing out from the inclined mortar layer 17a.

The composition of each mortar layer includes cement, powder silica and powder radiator radiating electromagnetic waves such as far-infrared rays composed of the powder of conglomerate hornfels (Tensyo-Seki) and the like, and the component ratio thereof includes on the basis of a powder silica of 100 parts by weight a cement of 35 to 40 parts by weight and the radiator mentioned above of 7 to 9 parts by weight.

A method to use the sauna room 1 of Embodiment 1 as constituted in a manner mentioned above is explained as follows.

As shown in FIG. 1, the heating part 5 works to circulate hot water of 45° C. to 70° C. from the heating part 5 to the hot-water supplying pipe 6a or the floor mortar layer 25 is heated to accumulate heat by a heating pipe or electric heating sheet, followed by heating the mortar layer for bathers 15, the inclined mortar layer 17a and the slab rock radiator 16 with heat conduction via the fixing mortar 26 to regulate their surface temperatures at 37° C. to 50° C. Far-infrared rays in addition to heat of the heat source are radiated from the radiator of each mortar layer, the slab rock radiator 16 and the cobbled stone part 17, followed by warming a bather with both of this heat and far-infrared rays. Furthermore, hot water (40° C.±3° C.) is sprayed on the mortar layer for bathers 15, the slab rock radiator 16, the floor mortar layer 25, the cobbled stone part 17b or the like in an interval of 2 to 4 hours automatically or by operator, followed by regulation of humidity in the room to 60% to 95%. According to these procedures, heat is highly radiated to warm the sauna room 1 due to the powder radiator composed of powder of conglomerate hornfels (Tensyo-Seki) or the like applied to each mortar layer employed at various places, followed by a reduction of a difference in the surface temperatures between the mortar layer for bathers 15 and the slab rock radiator 16 and the room temperature of the sauna room 1, resulting in regulation of room temperature in a range of 36° C. to 49° C. In addition to this, the heat in the warmed sauna room 1 is conducted to the mortar layer for wall 13, the slab rock radiator for wall 13a and the cobbled stone part of wall 13b, followed by radiation of far-infrared rays in addition to radiating heat to the mortar layer for wall 13, the slab rock radiator for wall 13a and the cobbled stone part of wall 13b to warm a bather by both of such heat and far-infrared rays. Furthermore, the sheet layers reflecting far-infrared rays 8, 11, 21 and 23 and the heat insulating material layers 9, 10 and 22 are applied in the ceiling part 2, the side wall part 3 and the floor part 4 respectively prevent heat and far-infrared rays in the sauna room 1 from being lost to the outside, this enhances the sauna effect and energy savings.

A bather bathes by lying directly on the mortar layer for bathers 15 and the slab rock radiator 16 or on a sheeting such as straw mats, towels and sheets sheeted thereon. The sweat or the like perspired by the bather is drained out from the wastewater catchment part 17 to the drain ditch 4a via drainage part 4c. In cleaning work, the drainage is also drained out from the wastewater catchment part 17 to the drain ditch 4a via drainage part 4c.

By virtue of the sauna room of Embodiment 1 constituted as mentioned above, following effects can be obtained.
(1) The heat supplied from the heated hot-water supplying pipe 6a is conducted, via the floor mortar layer 25, to the cobbled stone part 17b of the radiator, the mortar layer for bathers 15, the inclined mortar layer 17a and the slab rock radiator 16, followed by radiation of far-infrared rays from the cobbled stone of the cobbled stone part 17b or the like, radiators of each mortar layer and the slab rock radiator 16 in addition to the heat from the heat source 6 to warm a bather by both of such heat and far-infrared rays; this enhances the sauna effect as well as allows to set the temperature of the heat source 6 for the hot-water supplying pipe 6a or the like at a low level, resulting in enhancement of energy savings.
(2) The far-infrared ray effect of the radiator allows to lower the temperature of the heat source 6, this allows a bather to bathe at a low temperature, and the aged and patients suffering from high blood pressure or the like also to bathe.
(3) Even if heating is stopped, the slab rock radiator 16 has large thermal conductivity and radiates heat and far-infrared rays for a long time to the surrounding air, this enhances the heat retaining property.
(4) The inclined mortar layer 17a is equipped with the wastewater catchment part 17 at the downwardly inclined lowered position thereof, this allows wastewater such as water droplets and sweat to readily drain out, resulting in enhancement of hygiene and cleaning ability.
(5) Wastewater during cleaning work can be readily collected to the wastewater catchment part 17 of the inclined mortar layer 17a, this enhances cleaning-work ability.
(6) The waterproofing layer 20 prevents moisture coming out from the lower layers such as floor concrete slab layer 19 and the like, this allows to prevent heat of the heat source 6 from being lost and to enhance efficiency.
(7) The sheet layers reflecting far-infrared rays 8, 11, 21 and 23 are applied to the ceiling part, the side wall part and the floor part, this allows the radiated far-infrared rays to reflect back to the room, resulting in enhancement of the sauna effect and energy savings.
(8) The heat insulating material layers 9, 10 and 22 are applied to the ceiling part, the sidewall part and the floor part, this enhances the heat insulation effect and energy savings.
(9) The heating pipes of the heat source 6 are fixed by matching with a width of the reinforcing wire mesh 24 to place such heating pipes in a constant spacing, this allows to enhance the workability to fix the heating pipes and to prevent generation of local heated spots on the floor, resulting in not making a bather feel uncomfortable.
(10) Utilizing far-infrared rays allows to bathe at a low temperature, this allows the aged and physically weak persons to bathe and a bather to avoid burns resulting in enhancement of safety.
(11) Unnecessary water derived from moisture and sweat of a bather can be readily drained out through the cobbled stone part 17b from the wastewater catchment part 17 via the drainage part 4c to the drain ditch 4a, this allows the sauna room to be always maintained hygienic.
(12) The water used for cleaning the frame part 18 can be readily drained out from the wastewater catchment part 17 via the drainage part 4c to the drain ditch 4a, this allows to enhance cleaning-work ability.
(13) The cobbled stone part 17b formed in the inclined mortar layer 17a allows the water passed through the cobbled stone part 17b to readily flow down to the drainage part 4c, this allows to enhance drainage property to maintain hygiene.
(14) The surfaces of the mortar layer for bathers 15 and the slab rock radiator 16 are smoothly formed, this allows filth such as sweat or the like not to accumulate and to be easily cleaned up.
(15) Formation of the cobbled stone part 17b of the radiator allows to readily flow down unnecessary water coming from above without accumulating, this enhances hygiene.
(16) The heat in the sauna room 1 is conducted to the mortar layer for wall 13, the slab rock radiator for wall 13a and the cobbled stone part of wall 13b, followed by radiation of far-infrared rays from radiators of the mortar layer for wall 13, the slab rock radiator for wall 13a and the cobbled stone part of wall 13b in addition to the radiant heat to warm a bather with both of such heat and far-infrared rays; this enhances the sauna effect as well as allows to maintain the room temperature constant, resulting in enhancement of energy savings.
(17) The average particle diameter of the radiator is small, this allows to produce a mortar having fine texture and to uniformly disperse the radiator powder in each of the entire mortar layer.
(18) If the frame part 18 is detachably disposed, this allows to take it off for cleaning and to enhance cleaning-work ability and hygiene as well as maintenance ability because it can be easily exchanged especially when the frame part 18 made of wood shrinks due to water absorption.

(Embodiment 2)

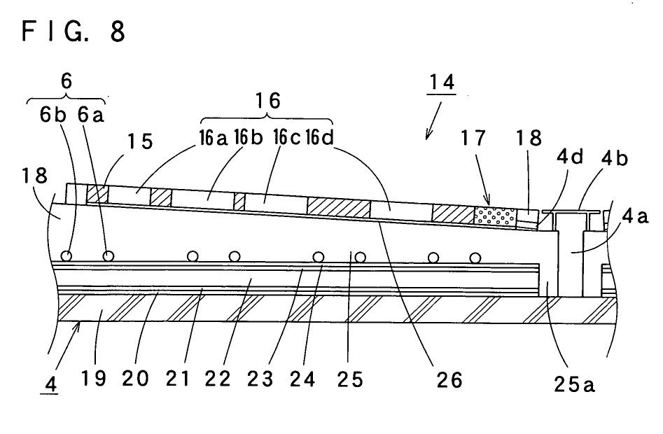

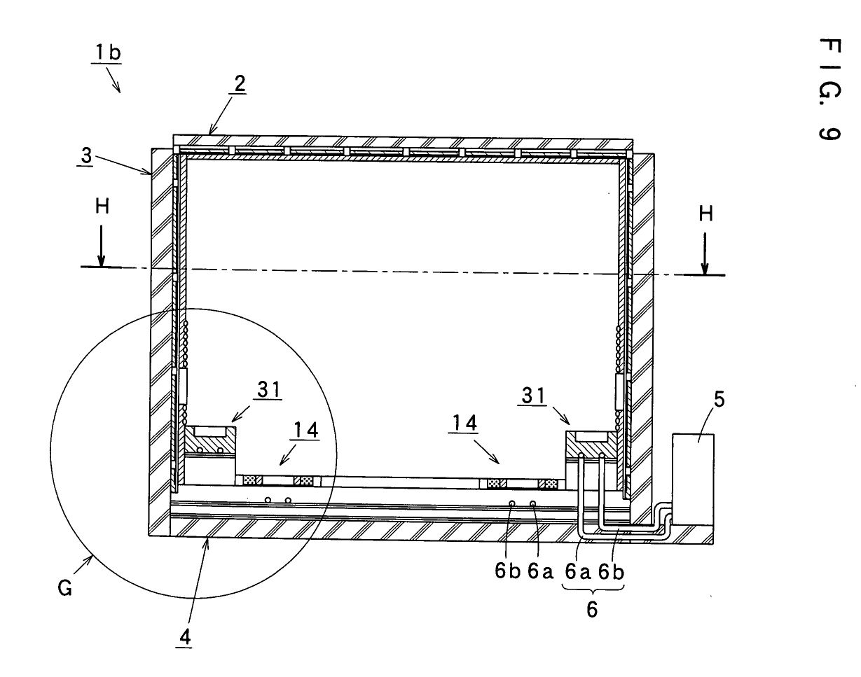

FIG. 7 is a sectional side view showing the outline of a sauna room of Embodiment 2. FIG. 8 is an expanded view showing the outline of a bathing part of a sauna room of Embodiment 2.

In FIG. 7, parts the same as those of Embodiment 1 are designated with the same marks and explanation is omitted.

Reference numeral 1a denotes a sauna room in Embodiment 2, Reference numeral 25′ denotes a floor mortar layer formed by inclining its side of the drain ditch 4a downwards, Reference numeral 27 denotes a water spray bar having spray nozzles equipped at the side wall to spray hot water of 40° C.±10, or preferably 40° C.±3° C. adjusted with hot water of the heating part 5 and tap water via a combination tap (not illustrated) equipped in the room, Reference numeral 28a denotes a humidity sensor to sense the humidity of the room, Reference numeral 28b denotes a temperature sensor equipped at a back face of the slab rock radiator 16 to sense the temperature of the slab rock radiator 16, Reference numeral 29 denotes a controller which, when the humidity sensor 28a detects the humidity being lower than 60%, opens a solenoid valve 30 of the water spray bar 27, or when detecting the humidity being 95%, closes the solenoid valve 30 to stop water spraying, and when the temperature sensor 28b detects the temperature being lower than 37° C., heats by the heating part 5, or when detecting the temperature being 50° C., stops heating. α denotes an angle of inclination of the floor mortar layer 25′ which conducts inclination of the floor face in a range of 1/100 to 10/100.

In FIG. 8, Reference numeral 4d denotes a drain hole formed by penetrating the frame part 18 at its side of the foot resting in approximately horizontal direction. Only by forming the drain hole 4d at the frame part 18, can waste water be easily and exactly drained out to the drain ditch 4a. The drain holes 4d are formed at 1 to 3 positions at the side of the bather's foot resting. By inclining the drain holes 4d in a manner to lower its side of the drain ditch 4a downward, drainage property is enhanced. The inclination angle of the drain holes 4d is almost the same as the inclination angle α of the floor mortar layer 25′.

Alternatively, in place of disposing the frame part 18 made of wood such as white cedar or the like, an outer enclosing frame composed of mortar or the like may be formed by covering peripheries of the mortar layer for bathers 15 and the wastewater catchment part 17 may be formed, and forming a drain hole penetrating the outer enclosing frame at its side of the foot resting in approximately horizontal direction may also be formed. Otherwise, at least without disposing the frame part 18 or the outer enclosing frame at the side of the foot resting, wastewater may be directly drained out to the drain ditch 4a.

By virtue of the sauna room of Embodiment 2 constituted as mentioned above, in addition to the effects obtained in Embodiment 1, following effects can be obtained.
(1) The floor mortar layer 25′ is formed by inclining in a manner to lower its side of drain ditch 4a downward, this allows to flow hot water sprayed from the water spray bar 27 over the whole floor to adjust humidity in the range of 60% to 95%, resulting in enhancement of humidity control property; and also allows to efficiently drain out the cleaning water during cleaning work, resulting in enhancement of workability.
(2) Since the humidity in the room is monitored by the humidity sensor 28a, when being out of optimal humidity range, hot water is sprayed by opening the solenoid valve 30 according to the signal transmitted from the controller 29, this allows to prevent the humidity from being reduced.
(3) Since the temperature of the slab rock radiator 16 is monitored by the temperature sensor 28b, the heating part 5 is controlled according to the signal transmitted from the temperature-humidity controller 29, this allows to maintain the slab rock radiator 16 at an optimal constant temperature.
(4) Only by forming the drain hole 4d at the frame part 18, wastewater is allowed to be easily and exactly drained out to the drain ditch 4a; this does not require to form the drainage part 4c at the floor mortar layer 25 or the like of the floor part 4, resulting in enhancement of constructing-work ability.
(5) Since the humidity is controlled by water spraying, steam allows to stimulate perspiration of a bather by action of the far-infrared ray effect, resulting in enhancement of the sauna effect.

(Embodiment 3)

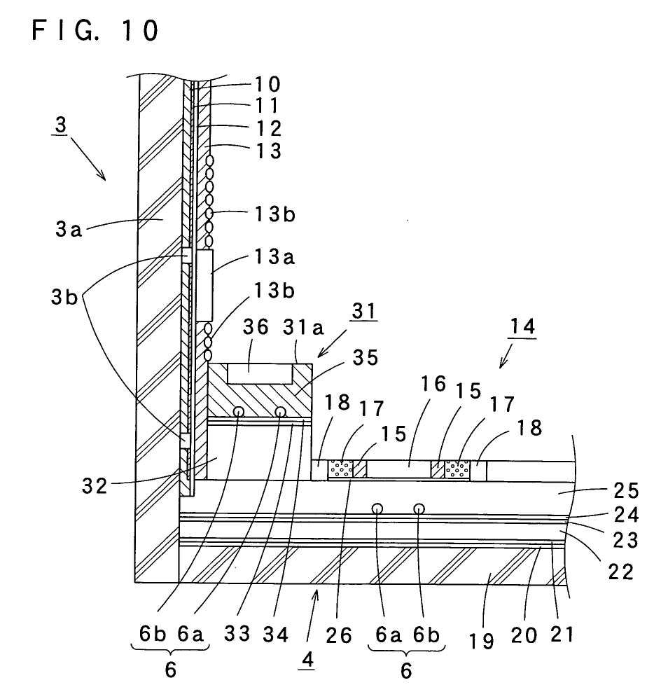

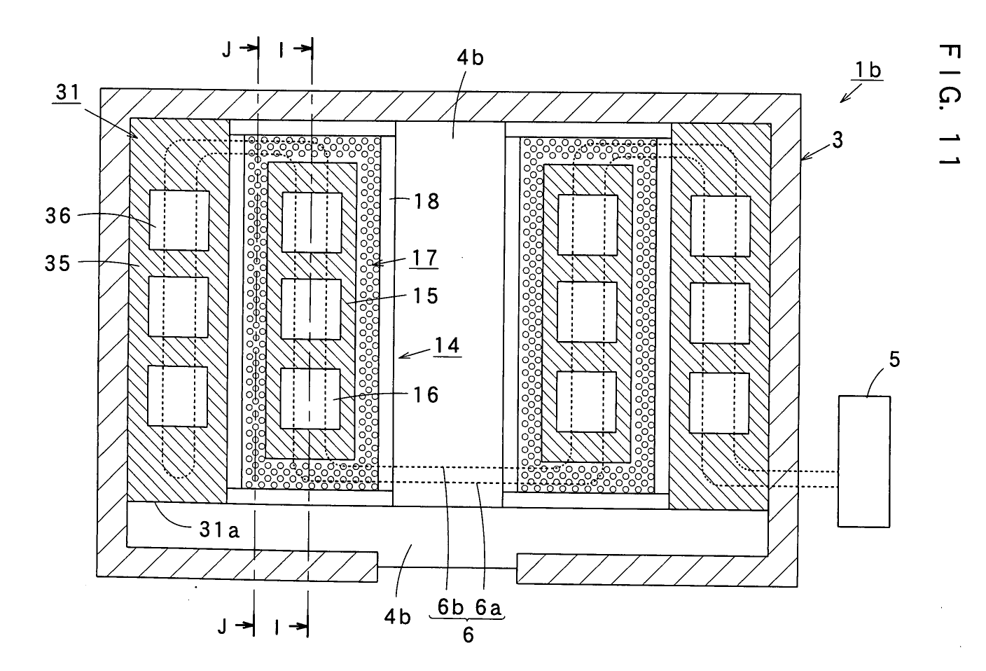

FIG. 9 is a sectional side view showing the outline of a sauna room of Embodiment 3, FIG. 10 is an expanded view showing the outline of G part in FIG. 9, FIG. 11 is a sectional view taken on line H-H of FIG. 9 as seen from the arrow direction. Parts are the same as those of Embodiment 1 are designated with the same marks and explanation is omitted.

In FIG. 9, Reference numeral 1b denotes a sauna room of Embodiment 3 and Reference numeral 31 denotes a chair for a foot bath having a seat part 31a on which a bather sits by resting the bather's feet on the slab rock radiator 16 of the mortar layer for bathers 15 disposed at a side of the bathing part 14.

In FIG. 10 and FIG. 11, Reference numeral 32 denotes an insulating material layer disposed on the floor mortar layer 25, Reference numeral 33 denotes a sheet layer reflecting far-infrared rays which is composed of aluminum sheets or the like and is laid on the insulating material layer 32, Reference numeral 34 denotes a reinforcing wire mesh disposed on the sheet layer reflecting far-infrared rays 33 and fixing the heat source 6 thereon, Reference numeral 35 denotes a mortar layer for chairs which is cast on the heat source 6 and contains a powder radiator radiating electromagnetic waves such as far-infrared rays including powder of conglomerate hornfels (Tensyo-Seki) or the like and Reference numeral 36 denotes a slab rock radiator which is embedded on the mortar layer for chairs 35 exposing the surfaces thereof and formed by conglomerate hornfels (Tensyo-Seki) or the like which radiates electromagnetic waves such as far-infrared rays to warm the lower half of a bather's body such as the thighs and bottom when the bather sits on the seat part 31a of the chair for a foot bath 31.

The slab rock radiator 36 has a size the same as the slab rock radiator 16 and is formed in a rectangular shape having thickness of approximately 30 mm and three plates thereof are laid in a predetermined spacing.

The height of the chair for a foot bath 31 is formed in a range of 300 mm to 800 mm. It is found that, if the height of the chair for a foot bath 31 becomes lower than 300 mm, it is difficult to sit in a comfortable position and to stand up; or if being higher than 800 mm, it is difficult to firmly touch the soles to the slab rock radiator 16 and to sit back.

Next, a description is given for a bathing part.

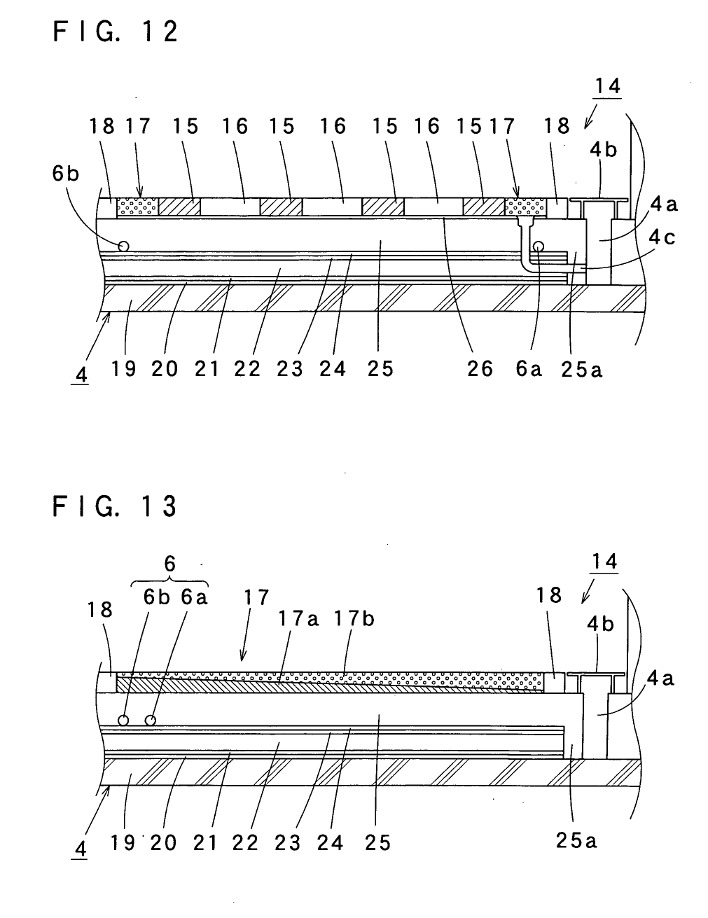

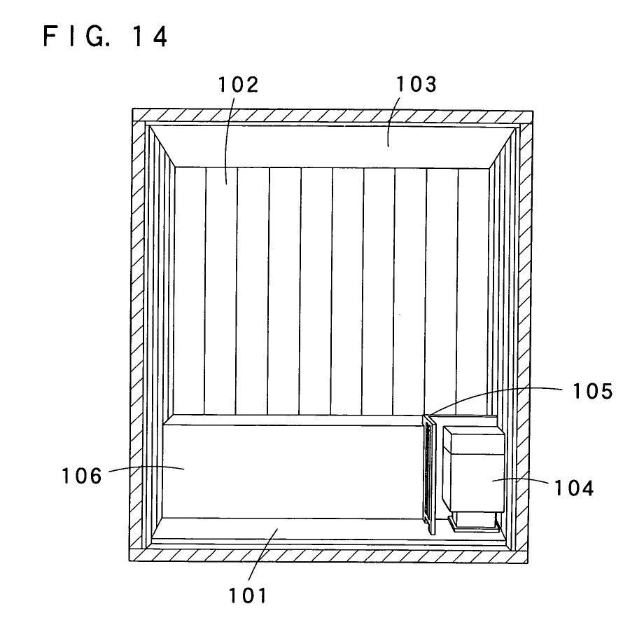

FIG. 12 is a sectional view taken out along an arrow of I-I of FIG. 11 and FIG. 13 is a sectional view taken our along an arrow of J-J of FIG. 11

In FIG. 12 and FIG. 13, the bathing part 14 is different from Embodiment 1 in the point such that the hot-water supplying pipe 6a and the hot-water refluxing pipe 6b are disposed almost parallel under the bathing part 14 and the chair for a foot bath 31 by crossing the longitudinal direction thereof.

Since the inclined mortar layer 17a of the wastewater catchment part 17 is formed by inclining in its longitudinal direction to lower its side of the drain ditch 4a downward, sweat derived from a bather and wastewater during cleaning work are allowed to exactly flow to the drain ditch 4a to exactly drain out. Since the cobbled stone part 17b formed on the mortar layer for bathers 15 and the inclined mortar layer 17a is horizontally formed, a bather does not feel uncomfortable when walking or resting the bather's feet on the slab rock radiator 16, resulting in enhancement of applicability.

A method to use the sauna room 1b of Embodiment 3 as constituted in a manner mentioned above is explained as follows.

A bather sits on the slab rock radiator 36 disposed on the seat part 31a of the chair for a foot bath 31 disposed at one of the sides of the bathing part 14 to rest the bather's feet on the slab rock radiator 16 of the mortar layer for bathers 15. According to this, a bather enables to warm not only the bather's soles but thighs and bottom by both of heat and far-infrared rays radiated from the mortar layer for chairs 35 of the chair for a foot bath 31 and the slab rock radiator 36. In addition to this, the heat in the warmed sauna room 1b is conducted to the mortar layer for wall 13, the slab rock radiator for wall 13a and the cobbled stone part of wall 13b, followed by radiation of far-infrared rays in addition to radiating heat to the mortar layer for wall 13, the slab rock radiator for wall 13a and the cobbled stone part of wall 13b to warm a bather by both of such heat and far-infrared rays. When sitting on the chair for a foot bath 31, by subjecting a bather's waist, back and shoulder to touch with the slab rock radiator for wall 13a and the cobbled stone part of wall 13b, the bather especially enables to warm the bather's whole body simply by the sitting position, resulting in enhancement of the sauna effect.

For a foot bath, a wall may be formed only with a conventional mortar wall. Alternatively, without forming the floor mortar layer 25, the slab rock radiator 16 may be formed directly on the heat source 6. Furthermore, the inclined mortar layer 17a and the cobbled stone part 17b may not be formed at the side of the chair for a foot bath 31 of the mortar layer for bathers 15. By virtue of this, the slab rock radiator 16 and the chair for a foot bath 31 may be disposed adjacently to each other, this enhances space saving.

Although, in this embodiment, the heating conduit including the hot-water supplying pipe 6a and the hot-water refluxing pipe 6b is applied as the heat source 6, a heating pipe and a heat conductive sheet may be used as the heat source 6.

Furthermore, in this embodiment, a chair for three bathers sitting side by side is constituted as one unit and two of the unit are disposed by opposing each other, but the arrangement of the slab rock radiator 16 and the chair for a foot bath 31 is not limited to such a manner; a small scale constitution for one or two bathers is possible to be disposed in a small space. In this case, as mentioned above, the floor mortar layer 25 may be omitted or a heat conductive sheet may be applied as the heat source 6 to reduce production costs.

By virtue of the sauna room of Embodiment 3 constituted as mentioned above, in addition to the effects obtained in Embodiment 1 or Embodiment 2, following effects can be obtained.
(1) Since the chair for a foot bath 31 is disposed at a side of the bathing part 14 where a bather sits, the bather can easily sit thereon by resting the bather's feet on the slab rock radiator 16 of the mortar layer for bathers 15; this allows the bather to warm the bather's soles by foot bath, and especially to relieve in a short time foot swelling resulting from working in a standing position and the like.
(2) Even a bather that finds it impossible to lie down on the mortar layer for bathers 15 or stand up therefrom by the bather himself/herself is allowed to easily take a foot bath only by sitting on the chair for a foot bath 31 to rest the bather's feet on the slab rock radiator 16 of the mortar layer for bathers 15.
(3) The heat radiated from the heated heat source 6 is conducted to the slab rock radiator for chairs 36 via the mortar layer for chairs 35, followed by radiation of far-infrared rays from the radiator of the mortar layer for chairs 35 and the slab rock radiator 36 in addition to the heat from the heat source 6; both of such heat and far-infrared rays enable to warm not only the soles but the whole lower half of a bather's body such as the thighs and bottom or the like, to enhance the sauna effect, to set the temperature of the heat source 6 at a low level and to enhance energy savings.
(4) When sitting on the chair for a foot bath 31, the mortar layer for wall 13 is arranged to touch a bather's waist, back, shoulder or the like by resting the bather's back on such a mortar layer for wall 13, far-infrared rays radiated from the radiator contained in the mortar layer for wall 13 directly acts on the upper half of a bather's body, resulting in enhancement of the sauna effect.
(5) When the slab rock radiator 13 and the cobbled stone 13b of the radiator are embedded on the mortar layer for wall 13 exposing their surface, the far-infrared ray effect is further enhanced up to an order at which the sauna effect can be provided only by sitting on the chair for a foot bath 31 as much as by lying back down on the mortar layer for bathers 15; this allows even a bather with a disabled leg to easily bathe.
(6) Sitting on the chair for a foot bath 31 to warm a bather from the bather's soles by the slab rock radiator 16 allows to enhance blood circulation even in the soles located furthest apart from the heart, to smoothly stimulate perspiration and to enhance the sauna effect.

### INDUSTRIAL APPLICABILITY

As mentioned above, the sauna room of the present invention enables to obtain the following advantageous effects as set forth in Claim 1.
(1) To provide a sauna room wherein, since the slab rock radiator radiates far-infrared rays in addition to the heat from the heat source, followed by warming a bather with both of such heat (infrared rays) and far-infrared rays, the sauna effect is enhanced, a temperature of the heat source is allowed to be set at a low level and energy savings are enhanced.
(2) To provide a sauna room wherein, since high humidity in the room allows to significantly enhance the far-infrared ray effect via water in the moisture as well as to set the temperature of the heat source at a low level due to the far-infrared ray effect of the slab rock radiator, a bather is allowed to bathe at a low temperature and the aged and patients suffering from high blood pressure or the like are also allowed to bathe.
(3) To provide a sauna room wherein, since, even if stopping to heat the heating part, the slab rock radiator has high thermal conductivity and radiates heat and far-infrared rays for a long time to the surrounding air, heat retaining property is enhanced.
(4) To provide a sauna room wherein, since, by virtue of forming the wastewater catchment part at a side of the mortar layer for bathers, wastewater generated at the mortar layer for bathers such as water droplets and sweat or the like is allowed to be readily collected, hygiene is enhanced.
(5) To provide a sauna room wherein, since, by virtue of forming the wastewater catchment part at a side of the mortar layer for bathers, water for cleaning is allowed to be readily collected during cleaning work, cleaning workability is enhanced.
(6) To provide a sauna room wherein, when a powder radiator is uniformly dispersed in the mortar layer for bathers, the sauna effect is allowed to be enhanced by the far-infrared ray effect.
(7) To provide a sauna room wherein, since the temperature to heat the heat source is allowed to be set at a low level, the mitigation effect is enhanced.

According to the invention as set forth in claim 2, in addition to the effects as set forth in claim 1, the following advantageous effects are obtained.
(1) To provide a sauna room wherein, since the floor mortar layer containing a powder radiator radiating electromagnetic waves such as far-infrared rays is disposed between the floor part and the mortar layer for bathers, heat retaining property and energy savings are enhanced.
(2) To provide a sauna room wherein, since the heat supplied from the heated heat source is conducted to the floor mortar layer, followed by warming a bather with both of heat and far-infrared rays radiated from the floor mortar layer, the sauna effect is enhanced, the temperature of the heat source is allowed to be set at a low level and energy savings are enhanced.
(3) To provide a sauna room wherein, since the far-infrared ray effect of the floor mortar layer can adjust the temperature of the heat source at a low level for bathers to bathe at a low temperature, safety is enhanced by preventing the bather from burning, and safety and applicability are enhanced for the aged and patients suffering from high blood pressure or the like to bathe.
(4) To provide a sauna room wherein, since the powder radiator is uniformly dispersed in the floor mortar layer, the sauna effect is enhanced by the far-infrared ray effect, resulting in enhancement of efficiency.

According to the invention as set forth in Claim 3, in addition to the effects as set forth in Claim 2, the following advantageous effects are obtained.
(1) To provide a sauna room wherein, since the waterproofing layer prevents moisture coming out from the floor concrete slab layer, heat retaining property as well as energy savings are enhanced.
(2) To provide a sauna room wherein, since the heat insulating material layer is disposed on the floor part, heat retaining property as well as energy savings are enhanced.
(3) To provide a sauna room wherein, since the heat source is fixed by matching with a width of the reinforcing wire mesh to maintain the heat sources in constant spacing, workability to fix the heat sources is enhanced, generation of local heated spots on the floor is prevented and uniform heating is allowed.
(4) To provide a sauna room wherein, since the heat supplied from the heated heat source is conducted to the floor mortar layer to warm a bather with both of heat and far-infrared rays radiated from the cobbled stone part of the radiator, the floor mortar layer and the mortar layer for bathers, the sauna effect is enhanced, the temperature of the heat source is allowed to be set at a low level and energy savings are enhanced.

According to the invention as set forth in Claim 4, in addition to the effects according to any one of claims 1 to 3, the following advantageous effects are obtained.
(1) To provide a sauna room wherein, since unnecessary water derived from moisture and sweat of a bather can be readily drained out from the wastewater catchment part via the drainage part to the drain ditch, the sauna room is always maintained hygienic.
(2) To provide a sauna room wherein, since the water used for cleaning the mortar layer for bathers and the slab rock radiator can be readily drained out from the wastewater catchment part via the drainage part to the drain ditch, cleaning-work ability is enhanced.
(3) To provide a sauna room wherein, since having the floor mortar covering layer formed by covering edges of the waterproofing layer, the heat insulating material layer and the reinforcing wire mesh prevents the water drained to the drain ditch formed on the floor mortar covering layer and/or the floor mortar layer from penetrating into layers between from the waterproofing layer to the reinforcing wire mesh on the floor part, reliability is enhanced.

According to the invention as set forth in Claim 5, in addition to the effects according to any one of claims 1 to 4, the following advantageous effects are obtained.
(1) To provide a sauna room wherein, since the sheet layer reflecting far-infrared rays disposed on the floor part can reflect the radiated far-infrared rays to the inside of the room, efficiency is enhanced.
(2) To provide a sauna room wherein, if a sheet layer reflecting far-infrared rays is disposed under the heat insulating material layer, not only is the far-infrared ray effect by the action of the far-infrared ray reflection enhanced but a water shielding effect is co-exerted.
(3) To provide a sauna room wherein, if a sheet layer reflecting far-infrared rays is disposed under the reinforcing wire mesh, even infrared rays are reflected to enhance energy savings.
(4) To provide a sauna room wherein, since disposing the sheet layer reflecting far-infrared rays on and/or under the heat insulating material layer allows to prevent heat loss from the ceiling part, side wall part and floor part, the temperature in the bath room can be easily controlled and the temperature in the bath room can be maintained almost constant throughout the seasons, resulting in enhancement of operation stability and reliability.

According to the invention as set forth in Claim 6, in addition to the effects according to any one of claims 1 to 5, the following advantageous effects are obtained.
(1) To provide a sauna room wherein, since the cobbled stone part formed by laying cobbled stones on or by embedding in the inclined mortar layer allows the water passed through the cobbled stone part to readily flow down to the drainage part, drainage property is enhanced resulting in enhancement of hygiene.
(2) To provide a sauna room wherein, since, if the inclined mortar layer is detachable, it can be taken off for cleaning, cleaning-work ability and hygiene are enhanced.
(3) To provide a sauna room wherein, since formation of the cobbled stone part allows to readily flow down, without accumulating unnecessary water coming from above, hygiene is enhanced; and since the cobbled stone laid is recoverable for washing, hygiene is further enhanced.
(4) To provide a sauna room wherein, since embedding the cobbled stones on the inclined mortar layer exposing the surfaces thereof does not allow the cobbled stones to be scattered, this prevents stones from being stolen and enhances cleaning-work ability.
(5) To provide a sauna room wherein, since embedding the cobbled stones on the inclined mortar layer exposing the surfaces thereof allows to produce a wastewater catchment part in a plant to transport to a construction site, productivity is enhanced.

According to the invention as set forth in Claim 7, in addition to the effects according to any one of claims 1 to 6, the following advantageous effects are obtained.
(1) To provide a sauna room wherein the heat insulating material layer and the sheet layer reflecting far-infrared rays applied to the side wall part and the ceiling part enhances energy savings.
(2) To provide a sauna room wherein, since the heat in the sauna room is conducted to the mortar layer for wall to radiate far-infrared rays as well as radiant heat the mortar layer for wall, followed by warming a bather with both of such heat and far-infrared rays, the sauna effect is enhanced and the temperature in the bath room can be maintained, resulting in enhancement of energy savings.
(3) To provide a sauna room wherein, since the heat insulating material layer and the sheet layer reflecting far-infrared rays applied to the side wall part and the ceiling part allows to maintain the temperature in the bath room, followed by allowing to lower the temperature of the heat source, the floor part is prevented from being too hot, comfortable bathing is allowed and bathing at a low temperature is allowed, resulting in allowing the aged and patients suffering from high blood pressure or the like also to bathe.

According to the invention as set forth in Claim 8, in addition to the effects according to any one of claims 2 to 7, the following advantageous effects are obtained.
(1) To provide a sauna room wherein, since the floor mortar layer is formed in a manner of slightly inclining downward to the drain ditch, the cleaning water is allowed to naturally drain out to the drain ditch during cleaning work, resulting in enhancement of cleaning-work ability.
(2) To provide a sauna room wherein, since, when the humidity in the room is lowered, water is sprayed from the water spray bar equipped to the side of the side wall to increase humidity, the humidity is adjustable to a high humidity side.
(3) To provide a sauna room wherein, since a high humidity state is always maintained by spraying water with the water spray bar, the far-infrared ray effect of conglomerate hornfels (Tensyo-Seki) or the like can be provided more efficiently, resulting in enhancement of energy savings.

According to the invention as set forth in claim 9, in addition to the effects according to any one of claims 1 to 8, the following advantageous effects are obtained.
(1) To provide a sauna room wherein, since the chair for a foot bath is disposed at a side of the mortar layer where a bather sits, the bather can easily sit thereon by resting the bather's feet on the slab rock radiator of the mortar layer for bathers, resulting in enhancement of versatility such that even a bather that finds it impossible to lie down on the mortar layer for bathers or stand up therefrom by the bather himself/herself is allowed to easily take a foot bath, and especially enhancement of effect to relieve in a short time foot swelling resulting from working in a standing position and the like.
(2) To provide a sauna room wherein, by sitting on the chair for a foot bath to warm a bather from the bather's sole with the slab rock radiator, blood circulation even in the soles located furthest apart from the heart can be enhanced and the sauna effect such as smoothly stimulating perspiration can be enhanced.

According to the invention as set forth in Claim 10, in addition to the effects as set forth in Claim 9, the following advantageous effects are obtained.
(1) To provide a sauna room wherein, since the heat radiated from the heated heat source is conducted to the slab rock radiator via the mortar layer for chairs, followed by radiation of far-infrared rays from the radiator of the mortar layer for chairs and the slab rock radiator in addition to the heat from the heat source, both of such heat and far-infrared rays enable to warm not only soles but a whole lower half of a bather's body such as the thighs and bottom, to enhance the sauna effect, to set the temperature of the heat source at a low level and to enhance energy savings.

According to the invention as set forth in Claim 11, in addition to the effects according to any one of claims 1 to 10, the following advantageous effects are obtained.
(1) To provide a sauna room wherein, since the silica has favorable heat-radiation ability, heat can be efficiently radiated from each mortar layer.

According to the invention as set forth in Claim 12, in addition to the effect according to any one of Claims 1 to 11, the following advantageous effects are obtained.
(1) To provide a sauna room wherein, since the radiator, due to its small average particle diameter, is allowed to be uniformly dispersed and to have a large surface area, the far-infrared ray effect can be enhanced. By the same reason, work of forming each mortar layer becomes easy, resulting in enhancement of workability.
(2) To provide a sauna room wherein, since a mortar having a fine texture can be produced, each mortar layer having a smooth surface can be formed, resulting in enhancement of hygiene.

According to the invention as set forth in Claim 13, in addition to the effects according to any one of claims 1 to 12, the following advantageous effects are obtained.
(1) To provide a sauna room wherein, since far-infrared rays are absorbed by and heats the water in moisture in the sauna room where the humidity is maintained in a range of an intermediate to a high humidity of 60% to 95%, the sauna effect can be sufficiently obtained at a low temperature, resulting in enhancement of energy savings and efficiency.
(2) To provide a sauna room wherein, since the humidity inside the sauna room is maintained in a range of an intermediate to a high humidity, functionality such that a bather having diseases of the nose, throat, respiratory system or the like can bathe safely, versatility and reliability are enhanced, and mitigation of the bather's symptoms with humidity in the room is enhanced.

The invention relates to a low-temperature sauna room utilizing the far-infrared ray effect, can provide a sauna room for full immersion bathing or foot bath which allows to bathe at a low temperature by utilizing the far-infrared ray effect of a radiator and is superior in hygiene, in safety by avoiding the possibility of falling over and burning, in energy savings by utilizing the far-infrared ray effect and in workability for construction and cleaning, and this sauna room of the invention is suitably used for private hyperthermia.

What is claimed is:

1. A sauna room comprising a heat source having at least one selected from a group of a heating conduit, heating pipe and electric heating sheet which supply heat to a floor part, a mortar layer for bathers which is formed on said floor part with a predetermined height and width, a slab rock radiator radiating electromagnetic waves such as far-infrared rays which is embedded on said mortar layer for bathers exposing the surfaces there of and a wastewater catchment part formed at least at one side of said mortar layer for bathers.

2. The sauna room as set forth in claim 1, further comprising a floor mortar layer disposed between said floor part and said mortar layer for bathers which contains a powder radiator radiating electromagnetic waves such as far-infrared rays.

3. The sauna room as set forth in claim 2, wherein the floor part comprises a floor concrete slab layer, a waterproofing layer disposed on said floor concrete slab layer, a heat insulating material layer disposed on the waterproofing layer, a reinforcing wire mesh disposed on said heat insulating material layer and the heat source fixed to said reinforcing wire mesh, and said floor mortar layer is formed on said heat source.

4. The sauna room according to any one of claims 1 to 3, further comprising a floor mortar covering layer formed by covering edges of said waterproofing layer, said heat insulating material layer and said reinforcing wire mesh of the floor, a drain ditch formed at said floor mortar covering layer and/or the floor mortar layer and a drainage part connecting said wastewater catchment part to said drain ditch.

5. The sauna room according to any one of claims 1 to 4, wherein the sauna room comprises a sheet layer reflecting far-infrared rays disposed on an upper and/or lower face of said heat insulating material layer.

6. The sauna room according to any one of claims 1 to 5, further comprising a detachable or fixed inclined mortar layer containing a powder radiator radiating electromagnetic waves such as far-infrared rays which is formed at least at one side part of said mortar layer for bathers in a manner that any one of the edges in the longitudinal direction thereof inclines downward and a cobbled stone part formed by laying cobbled stones of the radiators on said inclined mortar layer or by embedding cobbled stones of the radiators on said inclined mortar layer exposing the surfaces thereof.

7. The sauna room according to any one of claims 1 to 6, further comprising a side wall part vertically installed around said floor part and having said heat insulating material layer and/or said sheet layer reflecting far-infrared rays therein, a ceiling part installed above said side wall part and having said heat insulating material layer and/or said sheet layer reflecting far-infrared rays therein and a mortar layer for wall coating on a wall at room side of said side wall part.

8. The sauna room according to any one of claims 2 to 7, wherein said floor mortar layer is formed in a manner of inclining from a side of side wall downward to said drain ditch and a water spray bar is equipped at a side of said side wall.

9. The sauna room according to any one of claims 1 to 8, further comprising a chair for a foot bath disposed at a side of said bathing part where a bather sits by resting the bather's feet on said slab rock radiator of said mortar layer for bathers.

10. The sauna room as set forth in claim 9, wherein the chair for a foot bath comprises said heat source supplying heat to a seat of said chair for a foot bath, a mortar layer for chairs formed on the heat source containing the powder radiator radiating electromagnetic waves such as far-infrared rays and said slab rock radiator embedded on said mortar layer for chairs exposing the surfaces thereof.

11. The sauna room according to any one of claims 1 to 10, wherein each of said floor mortar layer, said inclined mortar layer, said mortar layer for bathers, said mortar layer for wall and said mortar layer for chairs containing on the basis of a powder silica of 100 parts by weight a cement of 25 to 45 parts by weight, or preferably of 30 to 40 parts by weight, and said radiator of 3 to 30 parts by weight, or preferably of 5 to 15 parts by weight.

12. The sauna room according to any one of claims 1 to 11, wherein an average particle diameter of said radiator is 0.00 mm to 0.5 mm.

13. The sauna room according to any one of claims 1 to 11, wherein humidity of a room is maintained in a range of an intermediate to a high humidity of 60% to 95%.
